(19) United States
(12) Patent Application Publication
(10) Pub. No.: US 2006/0047425 A1
(43) Pub. Date: Mar. 2, 2006

(54) Item search device

(75) Inventors: Makoto Fukumi, Kariya city (JP); Masatoshi Abo, Toyota-city (JP); Hanae Takahashi, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/199,236

(22) Filed: Aug. 9, 2005

(30) Foreign Application Priority Data
Aug. 30, 2004 (JP) 2004-250950
Jun. 20, 2005 (JP) 2005-179297

(51) Int. Cl. G01C 21/36

(52) U.S. Cl. 701/209; 701/200

(57) ABSTRACT

An item search device of the present invention includes, for an improvement of the usability of the item search device by facilitating an item search for a user, an electronic map data storage function for storing map data including a facility name and an area name as an object of an item search, a search function for searching a search item, a start point setting function for setting a start point in the map data, a distance calculation function for calculating a distance from the start point to a location of the search item, a rank function for ranking the search item based on the distance from the start point, a representation function for determining a representation of the search item according to a rank of the search item and a display function for displaying the representation of the search item.

### CROSS REFERENCE TO RELATED APPLICATION

This application is based on and claims the benefit of priority of Japanese Patent Application No. JP-A-2004-250950 filed on Aug. 30, 2004, and Japanese Patent Application No. JP-A-2005-179297 filed on Jun. 20, 2005, the disclosure of which is incorporated herein by reference.

### FIELD OF THE INVENTION

This invention relates to, for example, an item search device for searching an item used in a vehicular navigation system for navigating a user of the device to a travel destination such as an area or a facility of interest.

### BACKGROUND OF THE INVENTION

Conventional vehicles are equipped with a GPS (Global Positioning System), which is used to improve safety and efficiency of driving by detecting a current location of a vehicle and visually/audibly navigating the vehicle to a destination along an optimized route.

The navigation system generally includes an item search function for searching a facility name categorized by a place name, a prefecture name or the like besides having a basic display function for displaying a current location of the vehicle with a surrounding area on a map. The item search function is used by a user of the navigation system for setting the travel destination, a go-through place, a frequently-visiting place or the like. That is, the user searches for the destination or the like by the item search function, and then uses search items for setting the destination or the like.

The usability of the search function can be improved, for example, by showing a modified map of Japan with an accompanying list of prefectures. The prefecture in the modified map is highlighted by a mark or the like when the name of the prefecture is selected in the list. The usability of the search function is improved by visually distinguishing the destination for the ease of recognition upon finding the facility name or the like. In this manner, work load of the user is reduced and a search efficiency is improved in the item search device (Refer to Japanese Patent Document 1).

Further, Japanese Patent Document 2 discloses a navigation system that differently represents information based on a “use-by data” of the information. Furthermore, Japanese Patent Document 3 discloses a navigation system that categorizes the facilities for representing each category in a suitable color. Furthermore, Japanese Patent Document 4 discloses a navigation system that changes text colors in icons according to a price range of a parking or the like.

[Japanese Patent Document 1] JP-A-H09-292831

[Japanese Patent Document 2] JP-A-2004-085286

[Japanese Patent Document 3] JP-A-2003-207356

[Japanese Patent Document 4] JP-A-2004-069549

An example shown in Japanese Patent Document 1 does not visually distinguish the display the list of prefectures by, for example, using a different color for different area group of prefectures.

An example shown in Japanese Patent Document 2 does not always show latest information when update of the information is infrequent. Frequent update of the information leads to both of an increased cost of communication device in the navigation system and an increased running cost of an external connection for information retrieval.

An example shown in Japanese Patent Document 3 does not distinguish a featured facility by using a color scheme. This is inconvenient for selecting a facility by an attribute of features.

An example shown in Japanese Patent Document 4 does not display a full content of information in the icon on the map. The rest of the information is not available, nor the search result is not represented in a list form.

The conventional navigation systems described above do not provide to the user a clue for intuitive understanding of relationships between the items (headings) in the list such as name of the facility, distance to the facility, entrance fee, travel time, category of the facility and the like.

Further, the number of entries in the list is increasing in recent years. The turn-around time of each search is thus increasing. An intuitive way of representing a positional relationship of the listed items on the map for increased efficiency of the item search has not been realized by the conventional navigation systems.

### SUMMARY OF THE INVENTION

In view of the above-describe problems, it is an object of the present invention to provide an item search device that promptly searches items of interest in a decreased period.

The present invention discloses an item search device that solves the above-described problems. According to one aspect of the invention, the item search device includes an electronic map data storage function for storing map data including a facility name and an area name as an object of the search, a search function for searching a search item, a reference point setting function for setting a reference point in the map data, a distance calculation function for calculating a distance from the reference point to a location of the search item, a rank function for ranking the search item based on the calculated distance from the reference point, a representation function for determining a representation of the search item according to a rank of the search item and a display function for displaying the representation of the search item.

The present invention displays each entry of facilities in a list of a search result in an intuitively distinguishable manner that facilitates selection of listed information. That is, the improvement of visual recognition by assigning colors to listed information is taken into account, and thus the color of each entry of facilities in the list of the search result is determined based on a distance of each facility from the reference point. In this manner, a user of the item search device can visually and intuitively recognize positional relationships of the entries in the list of the search result. Therefore, required search time can be decreased, and search errors and/or re-searches can be prevented.

According to another aspect of the invention, the present invention includes a location registration function for registering a location selected by the user. Further, the reference point setting function uses the location registered by the location registration function as the reference point. In this manner, the search time for a facility of a user's interest is decreased.

According to further aspects of the invention, the reference point setting function of the item search device includes a current location detection function for detecting a current location of a vehicle, and the detected location of the vehicle is used as the reference point. In this manner, the location of the vehicle/the user is evaluated based on the distance to the facility of interest in the search. That is, travel time to the facility is visually represented by using a color scheme for the ease of recognition by the user. Therefore, the user can quickly select a facility that is within a scope of reach and is available for the user's convenience.

According to yet another aspect of the invention, the item search device includes an electronic map data storage function for storing map data including a facility name and an area name as a search item, a search function for searching the search item, a rank function for ranking the search item based on a location of the search item, a representation function for determining a representation of the search item according to a rank of the search item, and a display function for displaying the representation of the search item.

The present invention displays each entry of facilities in the list of a search result in an intuitively distinguishable manner that facilitates selection of listed information. That is, the improvement of visual recognition by assigning colors to listed information is taken into consideration. In this manner, the user of the item search device can visually and intuitively recognize positional relationships of the entries in the list of the search result. Therefore, required search time can be decreased, and search errors and/or re-searches can be prevented.

According to still yet another aspect of the invention, the item search device of the present invention uses at least one of a longitude and a latitude for representing an item location of the search item. In this manner, the location and the direction of the facility found in the search can be visually recognized by the user. The user can also quickly determine whether the facility exists in the area of his/her interest.

According to still yet another aspect of the invention, the item search device of the present invention uses the rank function for ranking the search item based on a latitudinal location of the search item, and uses the representation function for coloring the search item by using a cold-to-warm color gradation scheme as the latitude of the latitudinal location of the search item decreases. In this manner, location of the search item can visually be recognized because of the natural association of a color with the temperature/weather. That is, the cold color is generally associated with the cold weather/cold place high in longitude and the warm color is generally associated with the warm weather/warm place low in altitude. The user can quickly select the facility of his/her interest.

According to still yet another aspect of the invention, the item search device of the present invention changes the representations of the search items in the following manner. That is, the characteristic of the color assigned to each of the search items is changed for visual distinction. The search items can be sorted, for example, by an order of the distance from a current location, by an order of the price, by an order of the rating (number of stars), by an order of the name (alphabetical order), or the like. The higher items in the order may be represented by using reddish colors (warm colors) and the lower items may be represented by using bluish colors. In this manner, each of the search items can be visually distinguished. Therefore, the user can quickly select the facility of his/her interest.

According to still yet another aspect of the invention, the item search device of the present invention allows the user to select the use of the representation prepared by the item search device. The selection of the representation makes the visual recognition of the location and the direction of the search items easier for the user. In addition, the user can quickly find a facility of his/her interest in a list of the search items.

According to still yet another aspect of the invention, the item search device for solving the above-described items includes an information storage function for storing facility information, a condition input function for accepting a search condition for a search item from the user, a priority retrieval function for retrieving a priority of the facility information stored in the information storage function, a search function for searching the search item of the facility information by using the search condition accepted by the condition input function, a representation function for modifying a representation of the facility information in a list of the search items according to the priority of the facility information, and a display function for displaying the list by using the representation of the facility information.

The item search device of the present invention displays the search items in an order of priority that is determined by the user when the search items are displayed in a list. The item search device displays a high priority item first, thereby enabling the user for quickly selecting the facility of his/her interest without scrolling a displayed image.

According to still yet another aspect of the invention, the item search device includes a selection function for selecting an item in the facility information displayed by the display function, and a selection history storage function for storing the number or frequency of selection of each item in the facility information by the selection function. The priority retrieval function retrieves the number or frequency of selection stored in the selection history storage function, and the representation function determines the representation of the facility information based on the number or frequency of selection.

The large number of selection of specific facility information or high frequency of selection of the facility information indicates that the user frequently uses the selected facility. Therefore, the representation of the facilities, that is, items in the list of search, may reflect the number of selection or the frequency of selection to facilitate the user's selection of the facilities and/or selection operations in the list.

According to still yet another aspect of the invention, the item search device includes a communication function, and the priority retrieval function uses the communication function to retrieve the priority of the facility information.

The priority information stored in the item search device is preferably kept to be current for the use by the user. However, a constant update of the priority information is costly for the user. In addition, the priority information distributed by the information medium such as a CD-ROM or the like is out-of-date to certain extent, because of the lead time for the release of the information medium. The item search device of the present invention keeps the priority information to be up-to-date without increasing the burden of the user.

According to still yet another aspect of the invention, the item search device uses the priority retrieval function for retrieving plural types of the priorities, and uses the representation function for determining the representation of each of the plural types of priorities. The representations of the priorities are differentiated with each other by the representation function.

The criteria for priority selection may vary depending on the user, that is, some user gives selection number a top priority, while other user gives selection frequency or the like a top priority. Some user may prefer a certain combination of the priorities for the representation of the listed items. The item search device of the present invention is capable of accommodating a plurality of priorities for representation of the search items. Therefore, the user can quickly determine a facility/facilities of his/her interest, and can quickly select the facility in a small amount of time.

### BRIEF DESCRIPTION OF THE DRAWINGS

FIG. 1 is a block diagram of a navigation system of the present invention;

FIG. 2 is a flowchart of a list color configuration process;

FIG. 3 is a flowchart of a list color configuration process and search process;

FIG. 4 is an illustration of an example of a navigation menu on a display in the navigation system;

FIG. 5 is an illustration of an example of a configuration menu on the display;

FIG. 6 is an illustration of an example of a list color configuration menu on the display;

FIG. 7 is an illustration of an example of a destination search menu on the display;

FIG. 8 is an illustration of an example of a prefecture list on the display;

FIG. 9 is an illustration of an example of a shop list on the display;

FIG. 10 is an illustration of an example of a facility list on the display;

FIG. 11 is a flowchart of displaying the facility list sorted by a number of selection;

FIG. 12 is an illustration of an example of a facility list on the display based on a plurality of search conditions;

FIG. 13 is an illustration of an example of priority search conditions on the display; and

FIG. 14 is an illustration of an example of sort key selection menu used in a search.

### DETAILED DESCRIPTION OF THE PREFERRED EMBODIMENTS

An item search device for visually distinguishing each item on a list by using a color scheme is provided in order to decrease search time of a search item.

A preferred embodiment of the present invention will be described with reference to the drawings. This embodiment is an item search device used in a vehicle with a navigation system. The use of the item search device is not necessarily limited with the navigation system.

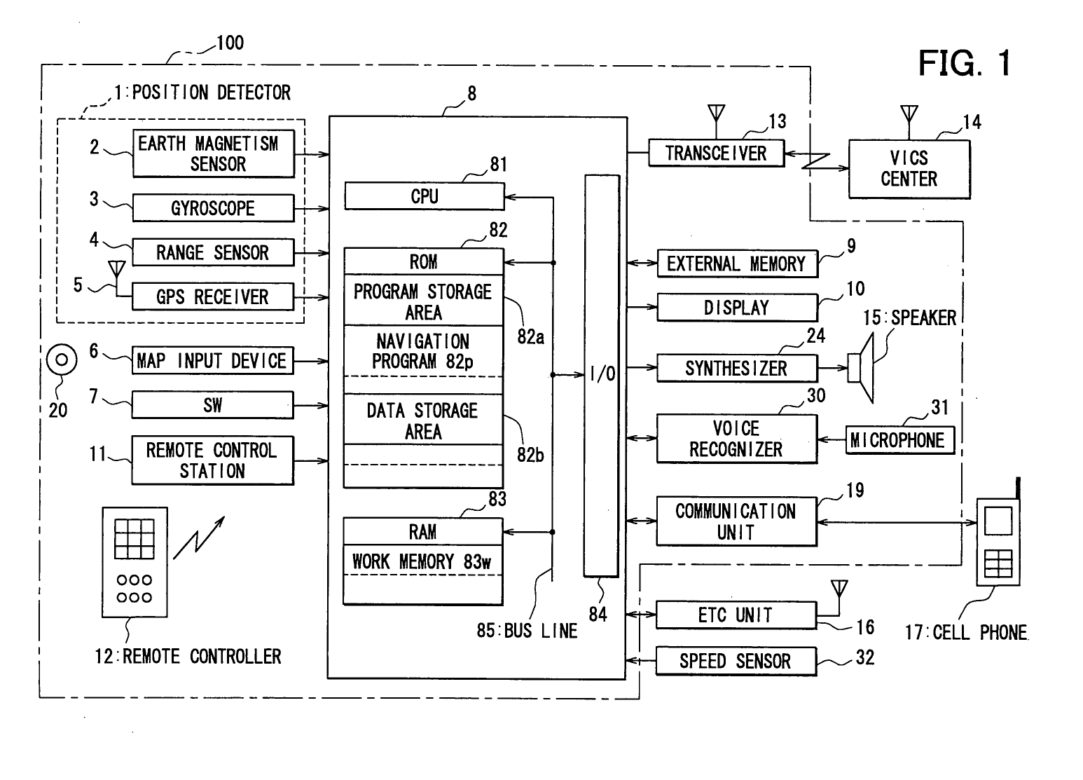

FIG. 1 shows a block diagram of a navigation system for a vehicle. The navigation system 100 includes a position detector 1, a map input device 6, switches 7, an external memory 9, a display 10, a remote control station 11, a remote controller 12, and a speaker 15, and a control circuit 8 that communicates with all of the above-described units.

The position detector 1 (a current position detecting function of the present invention) further includes a well-known type earth magnetism sensor 2, a gyroscope 3, a range sensor 4, and a GPS receiver 5 for receiving GPS signals from a satellite for position detection. These sensors in the position detector 1 have their own errors of different nature in position detection. These sensors in the position detector 1 compensate the errors in the position data by communicating with each other. These sensors may be used independently, or may be used with other sensors such as a steering rotation sensor, a wheel rotation sensor or the like.

The map input device 6 is used to input map data having attributes of roads and the like from a memory medium 20 (a map data storage means/a data storage means of the present invention) for increased accuracy of detected position based on a map matching. The memory medium 20 for storing the map data comes in a form of a CD-ROM, a DVD-ROM, a Hard Disk Drive (HDD), or a memory card. The memory medium 20 may also be other type of storage such as a memory card or the like. In addition, the memory medium 20 stores charge information and category information besides positional information of shops and facilities.

The map data is used to store and display map image information besides storing road network information including link information, node information and the like. The link information is the information about a section of a road that includes position coordinates, a distance of the section, travel time, road width, number of lanes, speed limit and the like. The node information is the information about an intersecting portion of the roads. The node information includes position coordinates, number of lanes for right/left turn, link to a connecting road and the like. The link to the connecting road includes trafficability of the connecting road or the like.

The switches 7 are, for example, disposed on the display 10. The switches 7 may be touch switches, mechanical switches or the like. The touch switches on the display 10 uses infrared sensors to detect x and y coordinates of the touching object for receiving an input. The switches 7 may be an input mouse of a computer system, or other type of pointing devices. The switches 7 and the remote controller 12 are used to give various instructions to the navigation system 100.

A voice recognizer 30 may also be used to give instructions. A microphone 31 connected to the voice recognizer 30 receives a voice input, and the voice is processed by using a voice recognition technology. The recognized voice is used as a command to control the navigation system 100.

The display 10 (a display means of the present invention) is a well-known type color liquid crystal display (LCD) that includes, for example, a dot matrix LCD and a driver circuit for controlling the LCD. The driver circuit uses, for example, an active matrix driving method of the LCD that securely regulates ON/OFF of each pixel having a transistor attached thereto. The driver circuit controls the display 10 based on an instruction signal from the control circuit 8 and image data. The display 10 may be an organic electro-luminescence display, or a plasma display.

A speaker 15 is connected to a well-know type voice synthesizer 24 through an I/O 84 of the control circuit 8. The speaker 15 is controlled by instructions from a navigation program 82p, and output analog voice synthesized by the voice synthesizer 24 based on a digital voice data stored in the external memory 9 or a hard disk drive (HDD). The voice synthesizer 24 outputs the analog voice by using a record and edit method that directly edits/connects stored waveform of voice, a parametric edit method that drives the synthesizer 24 with parameters of voice waveform, a rule-base synthesizing method that synthesizes the analog voice based on an analysis of the text strings or phonemics, or the like.

A speed sensor 23 includes a rotation detection device such as a rotary encoder. The speed sensor 23 detects, for example, the rotation of the tire in a proximity of the tire, and sends a pulse signal of detected rotation to the control circuit 8. The control circuit 8 converts the rotation of the tire for calculation of the travel time from a current location of the vehicle to a destination, or an average speed of the vehicle in each of the sections of a route to the destination.

A transceiver 13 (a priority retrieval means/a communication means of the present invention) is used in the present invention to communicate with VICS (Japanese Vehicle Information and Communication System). The information retrieved by the transceiver 13 is processed in the control circuit 8.

A cell phone 17 or a communication unit 19 can also be used to communicate with an external network such as the Internet for information retrieval. Further, the ETC unit 16 (Electric Toll Collection: a toll collection system in Japan) may be used for information retrieval into the navigation system 100. The ETC unit 16 communicates with the external network through a road-side station. Furthermore, the ETC unit 16, the cell phone 17, and the communication unit 19 may be used to communicate with the traffic information center 14 for information retrieval.

The control circuit 8 (a rank means/a reference point setting means/a representation means/a representation selection means/a search means/a distance calculation means/a priority retrieval means of the present invention) includes a well-know type CPU 81, a ROM 82, a RAM 83, and an I/O 84 with a bus line 85 as a connecting circuit. The CPU 81 processes a program and data in the ROM 82 and the RAM 83. The ROM 82 includes a program storage area 82a and a data storage area 82b. The program storage area 82a stores a navigation program 82p. The data storage area 82b stores required data for the navigation program 82p. The navigation program 82p uses a work memory 83w in the RAM 83. The function of the ROM 82 and the RAM 83 may be realized by using a hard disk drive when the map input device 6 uses the hard disk drive.

The navigation program 82p and the data used in the navigation program 82p may be stored in the hard disk drive when the navigation system 100 includes the hard disk drive. Read and write operations to the hard disk drive is controlled by an interface circuit included in the control circuit 8.

Further, the external memory 9 (a selection history storage means of the present invention) uses a readable/writable semiconductor memory such as an EEPROM (Electrically Erasable & Programmable Read Only Memory), a flash memory or the like, and stores data and information required for the operation of the navigation system 100. The external memory 9 retains the data and the information while an accessory switch is turned off (i.e., the navigation system 100 is turned off). Furthermore, the data required for the operation of the navigation system 100 may be stored in the hard disk drive when the navigation system 100 includes the hard disk drive.

The navigation device 100 described above operates in the following manner. That is, the control circuit 8 uses the CPU 81 to execute the navigation program 82p. Then, the navigation device 100 accepts an input by using the switches 7, remote controller 12 or the microphone 31 from a driver of the vehicle. In this manner, the driver selects a desired operation from a menu displayed on the display 10. The display 10 displays the route to the travel destination when the driver selects, for example, a “NAVIGATION” item in the menu. That is, when the driver specifies the destination in the map on the display 10, an optimum route to the destination is searched and displayed on the display 10 with the map based on a current location of the vehicle derived from GPS signal received by the GPS receiver 5 for navigating the driver. The display 10 displays a current position mark that represents a current position of the vehicle detected by the position detector 1, a map data that is retrieved from the memory medium 20, additional data that represents a route to the destination or the like, and a menu button for selecting items and switching screens. Search for the optimum route to the destination is executed by using Dijkstra method or the like.

The control circuit 8 associates the optimum route with landmarks such as an intersection, a tall building or the like. The landmarks are considered as guidance points. The navigation system outputs audio guidance for a driver of the vehicle as the vehicle passes prior-guidance points. The navigation system have prior-guidance points at multiple positions. For example, the audio guidance is output at the distances of 700 m, 300 m, and 100 m from an intersection in a local street, or at the distances of 2 km, 1 km, and 500 m from an exit in a freeway. The audio guidance is output from the speaker 15 at the prior-guidance points. The audio guidance may be replaced with guidance display shown on the display 10.

The display 10 and/or the speaker 15 are used to output not only the route guidance but also operation guidance and operation message according to the operation context of the navigation system.

(Color Configuration Process)

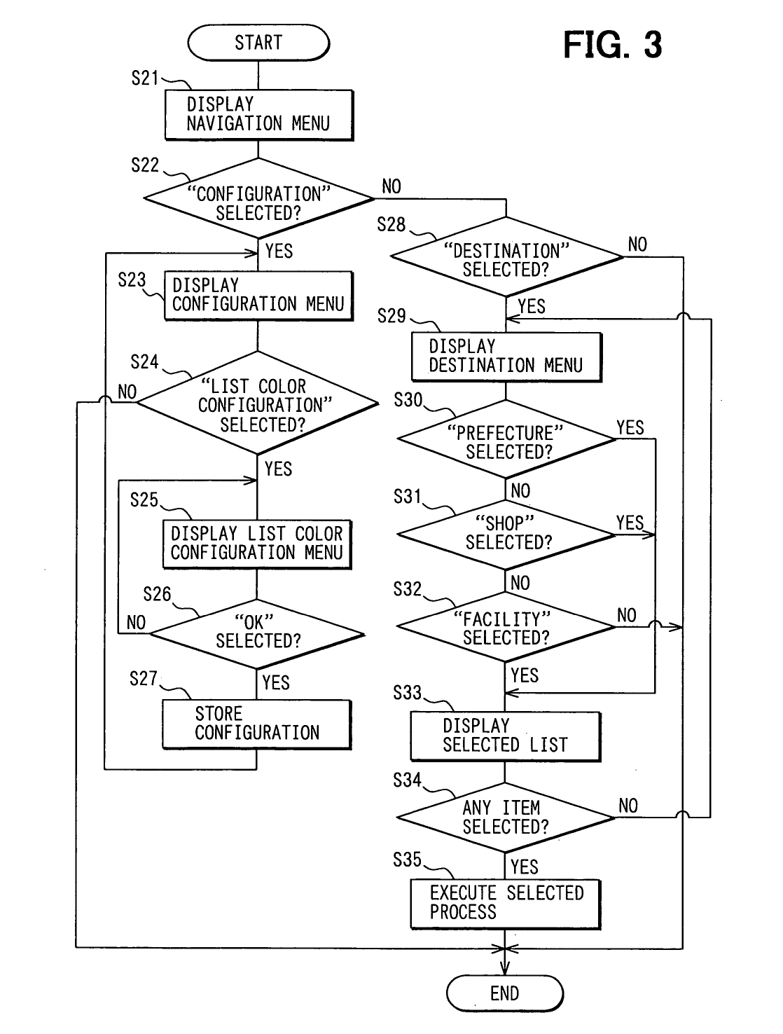

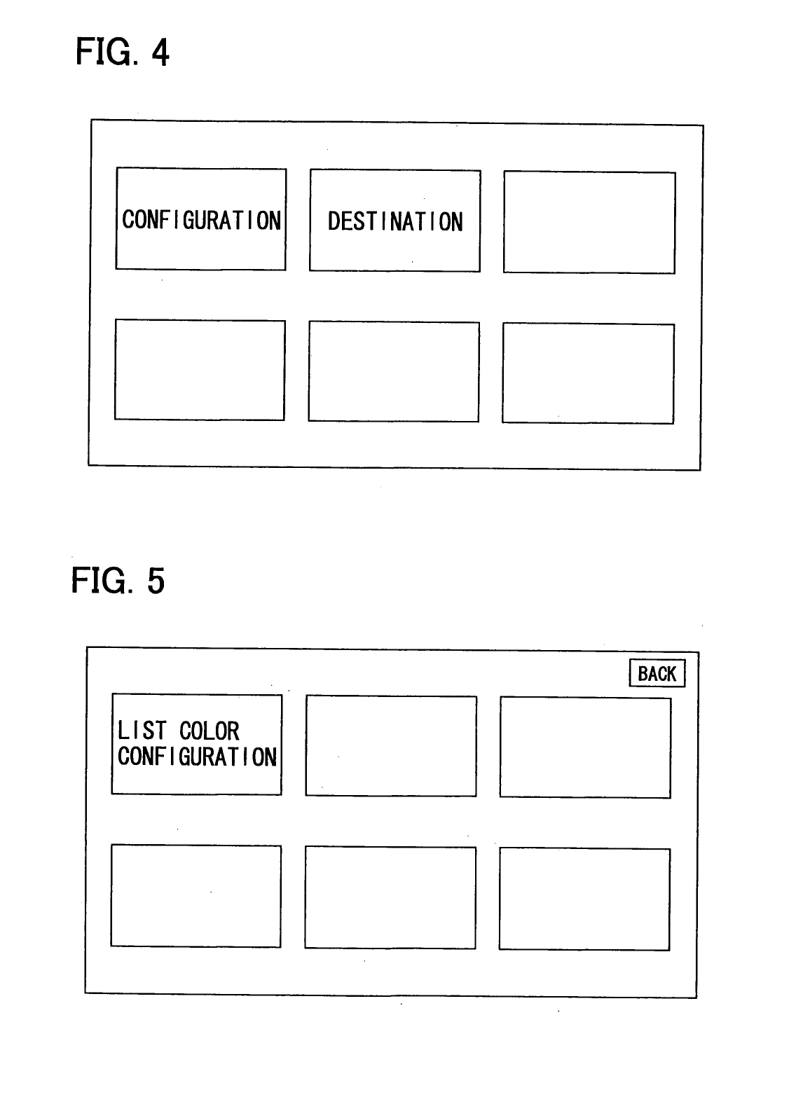

FIGS. 3 to 6 show the process of list color configuration in a search of destination. The list color configuration process is repeatedly executed with other processes of the navigation program 82p. FIG. 3 shows a flowchart for displaying a navigation menu in FIG. 4 when the driver operates the switches 7, or the remote controller 12, or speaks toward the microphone 31 (step S21 in the flowchart). White vacant buttons in FIG. 4 represent menu buttons that are not relevant to the list color configuration process. (So do the white vacant buttons in FIG. 5.)

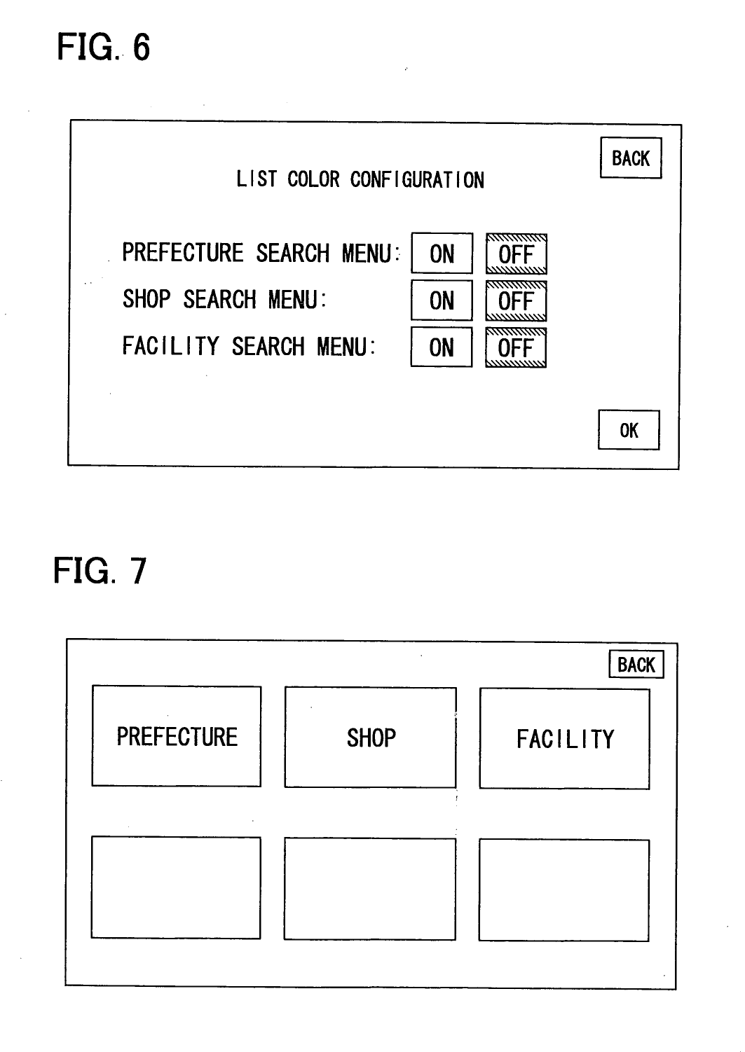

The display 10 displays a configuration menu (step S23) when “Configuration” button in FIG. 4 is selected (step S22: Yes). Then, the display 10 displays a list color configuration menu in FIG. 6 (step S25) when “List color configuration” button is selected (step S24: Yes).

The list color configuration menu in FIG. 6 allows the driver to respectively specify list color settings for each of the search result lists of prefecture names, shops, and facilities. In this case, prefecture names, shops, and facilities are all specified to be colored (ON is selected).

The items in the search result list may be specified not to color the list of the search result as a whole. Further, colors of area names (Kansai, Owari, Tounou or the like) or province names may be configured besides the prefecture names in the menu.

Selecting an “OK” button in the list color configuration menu (step S26: Yes) stores the configuration of the list color in a certain area of the external memory 9 (step S27), and the process goes back to the configuration menu in FIG. 5 (step S23). Selecting a “Back” button in the configuration menu displays the navigation menu in FIG. 4 on the display 10.

(Display Process)

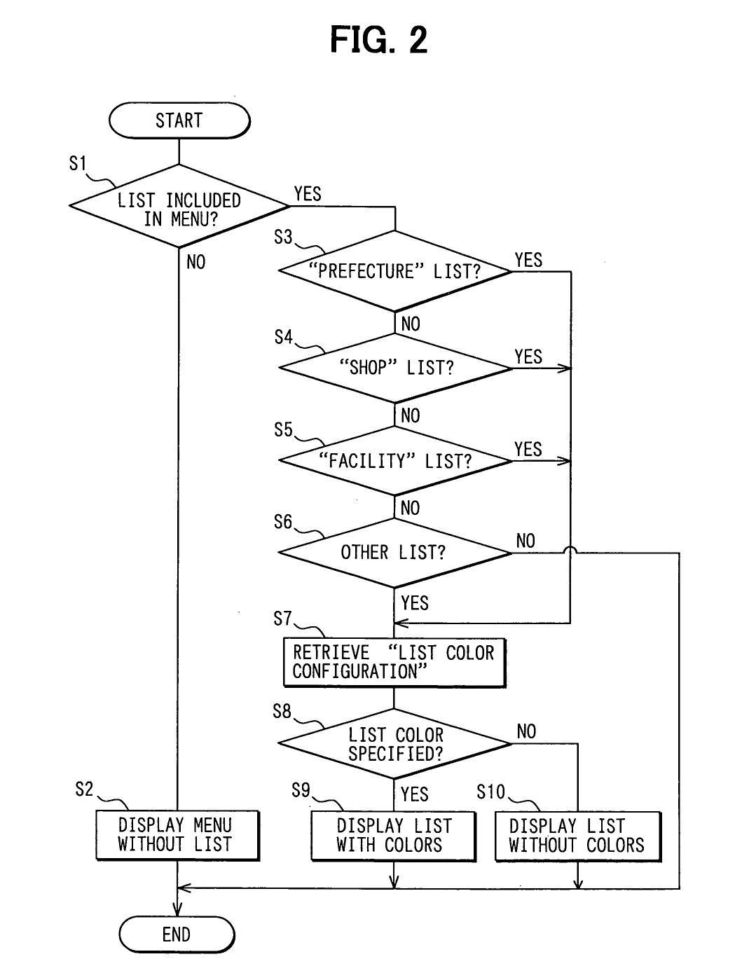

FIGS. 2, 3, 4, 7, 10, and 14 show a list item display process in the search. The list item display process is repeatedly executed with other processes as a part of the navigation program 82p. FIG. 3 shows the flowchart for displaying the navigation menu in FIG. 4 when the driver operates the switches 7, or the remote controller 12, or the driver speaks toward the microphone 31 (step S21).

Selecting a “Destination” button in FIG. 4 (step S28: Yes) displays a destination search menu in FIG. 7 on the display 10 (step S29). The driver selects a button in the destination search menu. That is, either “Prefecture” button, “Shop” button, or “Facility” button is selected (one of steps S30 to S32: Yes). White vacant buttons in FIG. 7 are the buttons not relevant to the list item display process (The button names are omitted.).

Selecting other button (step S32: No) terminates the list item display process. The data used for rank the shops and facilities is stored in the external memory 9 with categories of each grouping. The rank criteria may be input at the time of search. For example, FIG. 14 shows a rank method based on the sort key of distance from the current position of the vehicle, or a charge, or an area that contains the facility. The “Area” button may be omitted when “Prefecture” button is selected in the destination menu in FIG. 7. The reference point may be not only the current position of the vehicle, but also an arbitrarily specified point by the driver, or may be a location of a facility.

The reference point is determined in the following manner. The display 10 displays a menu for setting a reference point (not shown in the figure) when the driver either operates the switches 7/the remote controller 12, or speaks toward the microphone 31. The menu includes, for example, a current location of the vehicle, or a specific location. The current location detected by the position detector 1 is used as the reference point when it is selected in the menu. The specific location may be used as the reference point when the specific location is specified in the same manner as the destination of routing in a standard navigation operation. The reference point setting is stored in the external memory 9. The reference point may be selected from a list of previously used reference points.

Search result of the object of interest is shown in a list form when one of the buttons of search objects (Prefecture/Shop/Facility) is selected (step S33). Then, upon receiving selection of a desired item in the list (step S34: Yes), the navigation system 100 executes a route search to the desired item, or displays a description of the desired item (step S35).

(List Color Configuration Process)

The list color configuration process (step S33 in FIG. 3) is described with reference to a flowchart in FIG. 2. The display 10 displays a message such as “No list” or the like (step S2) when no item is found in a search (a button other than the “Prefecture” button, the “Shop” button, or the “Facility” button is selected) (step 1 No).

The navigation program 82p refers to the list color configuration stored in the external memory 9 (step S7) and checks if a selected button (Prefecture/Shop/Facility) has a color setting when the “Shop” or the “Facility” is searched in the destination menu in FIG. 7 upon receiving selection of one of the “Prefecture” button, the “Shop” button or the “Facility” button (one of steps S3 to S5: Yes). The list is colored (step S9) when the list color is turned on (step S8: Yes). The list is not colored (step S10) when the list color is not turned on (step S8: No).

The same process is executed when there is other list besides a prefecture list, a shop list, or a facility list (step S6: Yes).

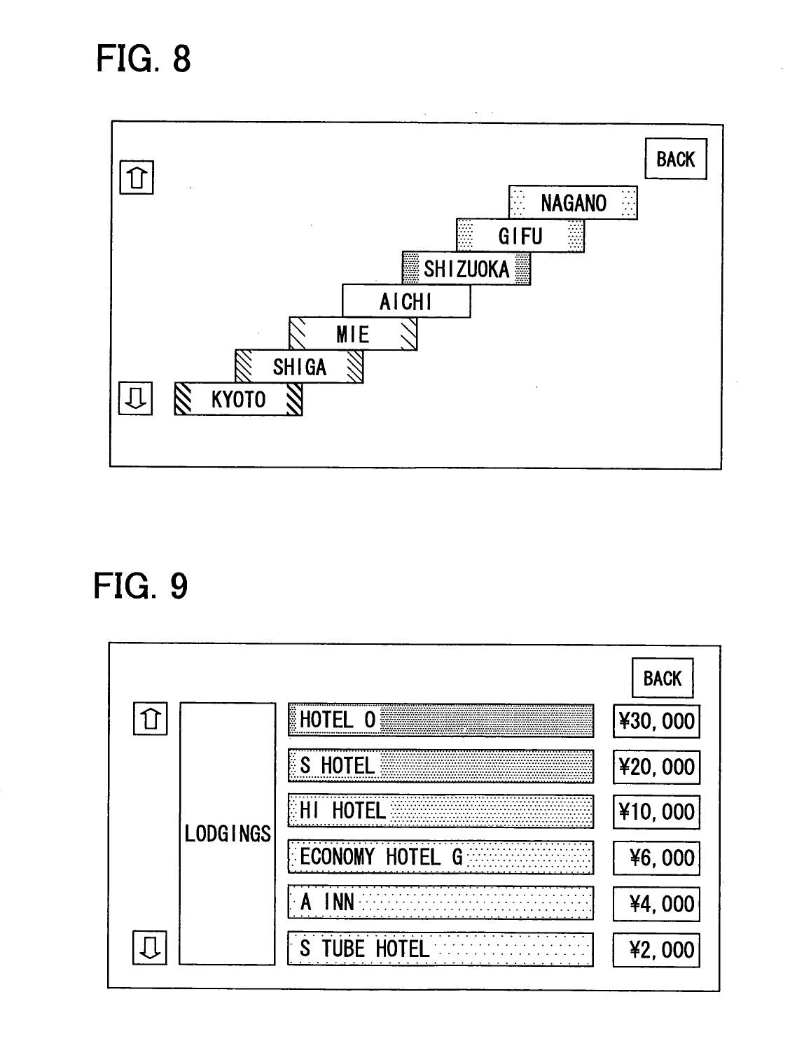

The list color configuration is explained with reference to the drawings. FIG. 8 shows an example of the Prefecture list having a color scheme when the “Prefecture” button in the configuration menu in FIG. 7 is selected. The prefecture list is sorted by, for example, information on the latitudinal position of the prefectures. The color scheme of gradation is used to reflect the latitudes of the prefectures. That is, prefecture of Hokkaido in the list is shown in a cold color (bluish color), and prefecture of Okinawa in the list is shown in a warm color (reddish color) as the latitudinal positions of those prefecture indicate. The color gradation increases when the latitude of the prefecture increases. FIG. 8 shows an example of color gradation where prefecture of Nagano is shown in most bluish color, with other prefectures such as Gifu and Shizuoka having a decreasing bluishness and an increasing reddishness toward a most reddish prefecture of Kyoto. Selecting the button of each prefecture shows a search menu of a place or a facility in the prefecture.

The color gradation scheme may be applied to area names instead of prefectures. That is, a gradation from a cold color to a warm color is applied to the following districts of Hokkaido, Tohoku, Kanto, Kou-shin-etsu, Tokai, Kinki, San-you, San-in, Shikoku, Kyushu, and Okinawa (Seinan islands) in Japan according to the latitudinal positions of the districts.

Unit of the color gradation scheme and each color used in the gradation is stored in the external memory 9. The unit and the color may be changed by the driver/a user of the navigation program 82p. The user specifies the unit and the color by the operation of the switches 7, the remote controller 12, or by the speech toward the microphone 31. The configuration menu not shown in the figure allows the user to specify the unit and the color.

FIG. 9 shows an example list of lodgings searched by the “Shop” button displayed in the menu in FIG. 7. The scope of search is limited to the lodgings, and the result is sorted by an order of rates. The color gradation reflects the order of rate. For example, a high-class hotel is shown in reddish color, while a low-class hotel is shown in bluish color. Color strength is increased toward both extremities, that is, toward the highest rate and toward the lowest rate. The order of display may be reversed from the cheapest to the most expensive. Selecting the button of each hotel displays the route to the hotel, or the description of the hotel.

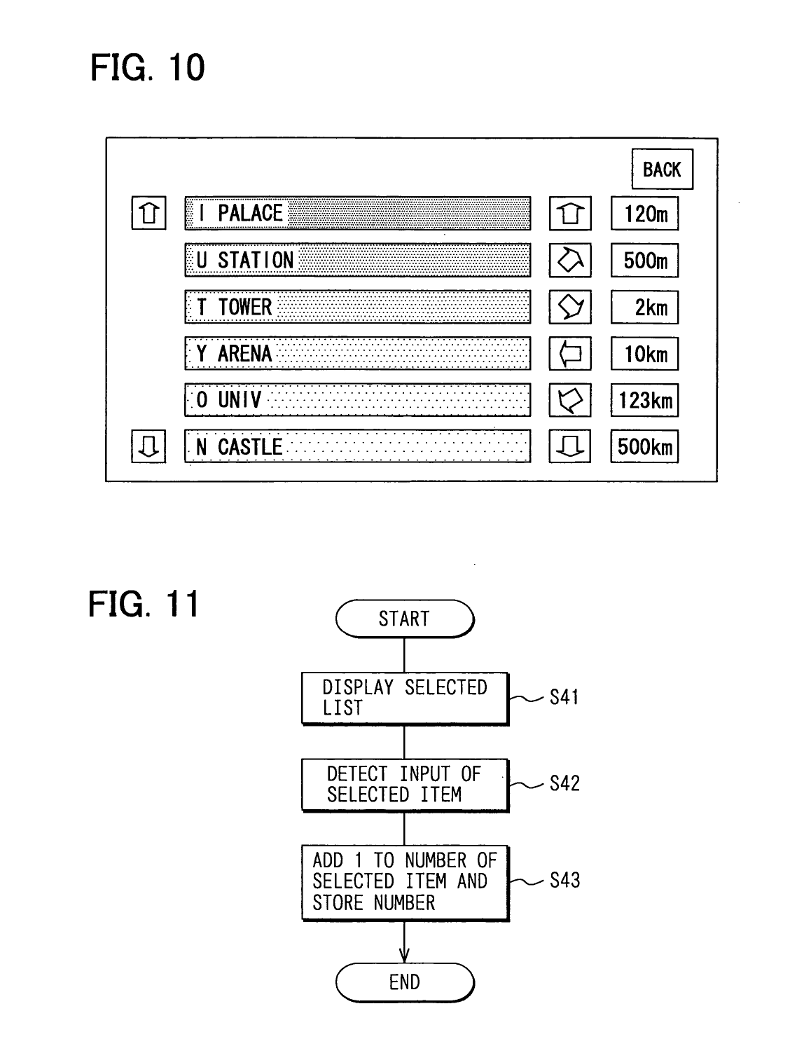

FIG. 10 shows an example list of facilities searched by the “Facility” button displayed in the menu in FIG. 7. The result is sorted by an order of distance from the current location of the vehicle to a facility. The color gradation reflects the order of distance and the direction to each facility is shown at the same time. For example, the facility in a short distance from the current location of the vehicle is shown in yellowish color, and the facility in a long distance is shown in bluish color. Color strength is increased toward both extremities, that is, toward the farthest and toward the nearest. The list in FIG. 10 shows names of the facilities, the direction of the facility from the current position of the vehicle, and the distance of the facility from the current position of the vehicle. Selecting the button of each facility displays the route to the facility, or the description of the facility.

Each entry in the listing of the shops or the facilities as a result of the search may include the prefecture as a display item. The prefecture indicates the location of the facility. The color scheme of prefecture may be applied to the prefecture item in each entry of the search result. The sort keys may be chosen by the user when there are two or more sort keys. The sort key may be specified when the search condition is input, or a list of the search result may be re-sorted according to a sort key on demand.

FIGS. 9 and 10 show a fixed number of entries in the search result list on the display 10 (6 entries in FIGS. 9 and 10). The color of the entry may also be fixed in this case, that is, red, orange, yellow, yellow green, green, blue, from top to bottom. Scroll of the entry by using up/down arrow buttons in the search result does not change the color of each entry when the color of the entry is fixed to each position in the menu. For example, S hotel in orange button in the second position from the top before scroll in FIG. 9 will be in red button in the first position from the top after scroll. The display position and the color are defined in a data table stored in the external memory 9.

The reference point used for ranking the facilities according to the distance may be the current location of the vehicle, or may be other location that is specified by the user. For example, a home of the user or a lodging may be used as the reference point. The reference point is specified by the configuration menu in FIG. 5. The color gradation scheme may reflect the latitudinal distance from the reference point. That is, the reference point of the user's input may be used as an origin o the gradation toward north and south, and the prefecture/the facility may be colored in a strong red/blue as the latitude of the prefecture/facility increase.

(Other Rank Method)

The list color configuration may be based on a priority of the facility in the following manner. FIG. 11 shows a flowchart of a priority setting process of a facility based on the number of selection in the list of the search result. The priority setting process is repeated with other processes in the navigation program 82p.

The priority setting process displays a list of search result as shown in FIG. 9 (step S41) when a hotel is an object of the search. The user selects the “Hotel O” in the list by pressing the “Hotel O” button on the display 10. The input by the user is detected as coordinates of the button, and the coordinates are sent to the CPU 81 in the control circuit 8 (step S42). The CPU 81 increments the number of selection of the “Hotel O” when a memory area in the external memory 9 is reserved for the storage of the number, or reserves the storage in the external memory 9 for the storage of the number of selection of “Hotel O” to have a count of 1 when there is no storage for the count (step S43).

The number of selection of a certain facility in the list is used as the priority. That is, the greater the number of selection is, the higher the priority becomes. In addition, frequency of selection in the last three month may be used to determine the priority. In this case, the higher the frequency of selection, the higher the priority becomes.

The priority of the shop or the facility may be based on a distance from the reference point, a charge, a popularity of word-of-mouth, a valuation by magazines, an importance in the vicinity, or an urgency for disregarding the distance and/or the charge. Further, the priority may be based on the factors such as the allowance of children/senior member, or the age.

The priority is respectively input for each facility/shop based on the popularity/valuation from the priority menu by the operation of the switches 7, the remote controller 12, or by the speech toward the microphone 31. The facility/shop may be specified by using a pointing device on the map shown on the display 10.

The priority may be retrieved from an external resource. For example, the transceiver 13/the cell phone 17/the communication unit 19 may be used to connect to the external network to access an information server for the retrieval of the priority. The information server and the navigation system 100 authenticate each other by exchanging a registered ID and a password. The priority is retrieved when the authentication is validated. The information server stores the priorities of various types in the above description. Those priorities are periodically updated based on the word-of-mouth information, the valuation of the magazines, or the like.

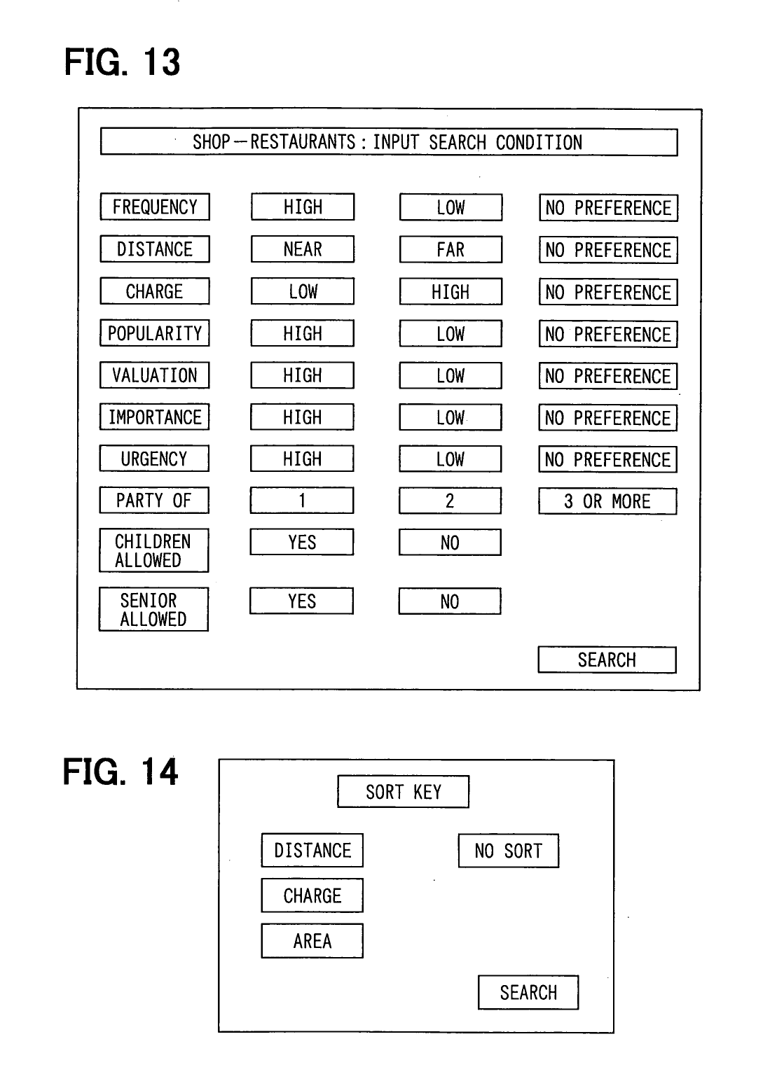

In a search for a hotel, the search condition menu including conditions of the distance, the charge, the priority and the like as shown in FIG. 13 is displayed after a category of the search is specified by selecting the “Shop” button or the “Facility” button in the destination menu. The priority may be input from a different menu. The search condition is shown with a default selection of conditions. The user may change the default selection of search conditions, and may execute the search by selecting the “Search” button.

The list of the search result may be displayed in a color scheme that reflects a plurality of search conditions when two or more search conditions are specified for the “Shop”/“Facility” search condition in the destination menu in FIG. 7. The priority of the search conditions is specified in the course of condition setting.

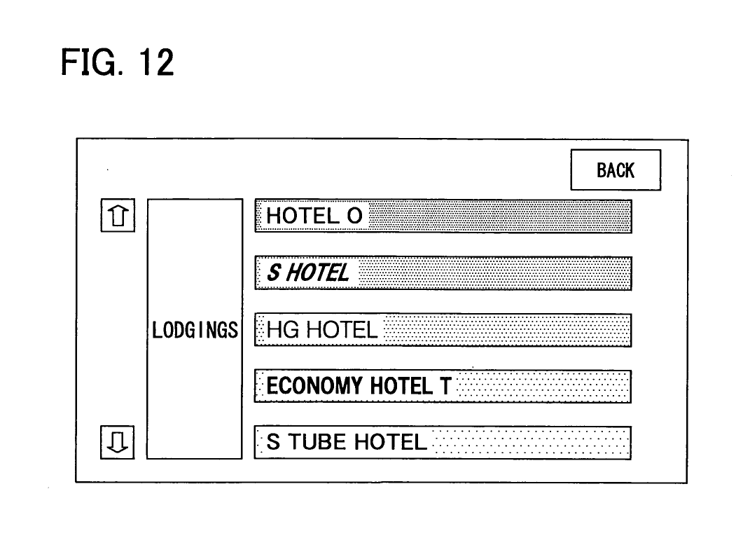

FIG. 12 shows an example list of hotels sorted by the popularity. The search result is differentiated by using different fonts and different colors. For example, a thick font indicates a high frequency of use, and an italicized font indicates an even more high frequency of use. The warm color indicates the high popularity and the cold color indicates the low popularity. The list in FIG. 12 is sorted in an order of popularity. The sort key can be changed to, for example, the frequency of use by double-clicking the name of the hotel in the list. That is, the text area in the list can be clicked twice in a certain period to change the sort key. The condition represented by the color scheme may be used as the sort key by double-clicking the colored area having no text, i.e., by clicking twice in a certain period.

It will be obvious to those skilled in the art that various changes and modifications may be made in the above-described embodiments of the present invention. However, the scope of the present invention should be determined by the following claims.

What is claimed is:

1. An item search device comprising:
an electronic map data storage means for storing map data including a facility name and an area name as a search item;
a search means for searching the search item;
a reference point setting means for setting a reference point in the map data;
a distance calculation means for calculating a distance from the reference point to a location of the search item;
a rank means for ranking the search item based on a distance from the reference point;
a representation means for determining a representation of the search item according to a rank of the search item; and
a display means for displaying the representation of the search item.

2. The item search device according to claim 1 further comprising a location registration means for registering a location selected by a user,
wherein the reference point setting means uses the location registered by the location registration means as the reference point.

3. The item search device according to claim 1 further comprising a current location detection means for detecting a current location of a vehicle,
wherein the current location detection means sets the current location of the vehicle as the reference point.

4. An item search device comprising:
an electronic map data storage means for storing map data including a facility name and an area name as a search item;
a search means for searching the search item;
a rank means for ranking the search item based on an item location of the search item;
a representation means for determining a representation of the search item according to a rank of the search item; and
a display means for displaying the representation of the search item.

5. The item search device according to claim 4,
wherein at least one of a longitude and a latitude of the item location defines the item location.

6. The item search device according to claim 5,
wherein the rank means ranks the search item based on a latitudinal location of the search item, and
the representation means colors the search item by using a cold-to-warm color gradation as the latitude of the search item decreases.

7. The item search device according to claim 6,
wherein the representation means assigns a respective color characteristic to each of the search item as the representation of the search item.

8. The item search device according to claim 7 further comprising a representation selection means for allowing a user to select the representation of the search item.

9. An item search device comprising:
an information storage means for storing facility information;
a condition input means for accepting a search condition for a search item from a user;
a priority retrieval means for retrieving a priority of the facility information stored in the information storage means;
a search means for searching the search item of the facility information by using the search condition;
a representation means for modifying a representation of the facility information in a list of the search items according to the priority of the facility information; and
a display means for displaying the list by using the representation of the facility information.

10. The item search device according to claim 9 further comprising:
a selection means for selecting the search item of the facility information displayed by the display means; and
a selection history storage means for storing either a number of selection or a frequency of selection of the search item of the facility information by the selection means,
wherein the priority retrieval means retrieves either the number of selection or the frequency of selection stored in the selection history storage means, and
the representation means determines the representation of the facility information based either on the number of selection or on the frequency of selection.

11. The item search device according to claim 10 further comprising a communication means for external communication,
wherein the priority retrieval means retrieves the priority of the facility information by using the communication means.

12. The item search device according to claim 11,
wherein the priority retrieval means retrieves plural types of the priorities,
the representation means determines a respective representation of each of the plural types of priorities, and
the representation means modifies the representation of the facility information in the list of the search items according to the respective priorities of the facility information.
